(19) United States
(12) Patent Application Publication
(10) Pub. No.: US 2025/0222426 A1
(43) Pub. Date: Jul. 10, 2025

(54) ACOUSTIC REACTOR

(71) Applicant: Oxford University Innovation Limited, Oxford (GB)

(72) Inventors: James Jing KWAN, Oxford (GB); Jason Lawrence RAYMOND, Oxford (GB)

(21) Appl. No.: 18/853,425

(22) PCT Filed: Apr. 21, 2023
(86) PCT No.: PCT/GB2023/051057

§ 371 Date: Oct. 2, 2024

(30) Foreign Application Priority Data
Apr. 21, 2022 (GB) 2205822.6

(51) Int. Cl. B01J 19/10; B01J 19/00

(52) U.S. Cl. CPC B01J 19/10; B01J 19/0006; B01J 19/008; B01J 2219/0801

(57) ABSTRACT

An acoustic reactor is provided, comprising a body defining a chamber for holding an ultrasound medium and a reactor vessel for receiving a reactant, the reactor vessel positioned in the chamber. An ultrasound transducer arrangement is configured to emit coherent ultrasound waves into the chamber. A reflector arrangement is arranged to reflect coherent ultrasound waves from the ultrasound transducer arrangement in opposing directions into the reactor vessel so as to form a standing wave in the reactor vessel.

The present invention relates to acoustic reactors, such as sonochemical reactors or cavitation reactors.

Sonochemistry is the use of high frequency (>20 kHz) sounds waves, also known as ultrasound, to facilitate chemical reactions. Typically the sound is used to nucleate gas/vapour bubbles (cavitation) that collapse as the main mechanism for the chemical reaction. As these bubbles collapse, they create highly energetic and reactive environments ideal for radical chemistry.

Sonochemistry is an inherently green process, and so could be used to replace conventional non-green techniques. However, cavitation requires a large amount of energy. Conventional acoustic reactors used for sonochemical reactions use multiple ultrasound transducers to generate ultrasound of sufficient energy, and focus the ultrasound down to a small area to increase the intensity of ultrasound applied to the reactants. However, this approach means that the chemical reaction only takes place in a small area. This has prevented reactors from being scaled up to industrial scales. Together with the non-specificity of the chemistry and the large amount of energy required to power the transducers, this has created a bottleneck in the industrial application of sonochemistry to valuable chemical reactions.

In accordance with a first aspect of the invention there is provided an acoustic reactor comprising: a body defining a chamber for holding an ultrasound medium; a reactor vessel for receiving a reactant, the reactor vessel positioned in the chamber; an ultrasound transducer arrangement configured to emit coherent ultrasound waves into the chamber; and a reflector arrangement arranged to reflect coherent ultrasound waves from the ultrasound transducer arrangement in opposing directions into the reactor vessel so that the reflected acoustic waves form a standing wave in the reactor vessel.

This acoustic reactor uses counter-propagating ultrasound waves to create a standing wave in the reactor vessel. Folding the waves in on themselves to form the counter-propagating waves creates a high intensity region within the reactor vessel. Folding the waves in this way means that less input electrical power is needed to generate cavitation, yielding a more energy-efficient process. The reaction area is not limited to a small area, allowing scale up of the reaction.

In some embodiments, the reflector arrangement comprises a first reflector configured to receive coherent ultrasound waves from the ultrasound transducer arrangement, and to reflect them in the opposing directions into the reactor vessel. Such an arrangement provides a space efficient apparatus for achieving the folding of the waves discussed above.

In some embodiments, the first reflector is annular and extends around the reactor vessel. Such an arrangement allows the first reflector to focus the ultrasound waves, and concentrate the power of the ultrasound waves providing a high intensity region in the reaction vessel.

In some such embodiments the reflector arrangement further comprises a second reflector configured to receive coherent ultrasound waves from the ultrasound transducer arrangement travelling outwardly and to reflect them towards the first reflector.

In some embodiments, the second reflector is annular and extends around the chamber. Such an arrangement allows the second reflector to collect outwardly travelling coherent ultrasound waves and direct them towards the first reflector. This is a convenient way to direct coherent ultrasound waves to the entirety of the first reflector, without the need to configure the ultrasound transducer arrangement to extend across the entire area of the first reflector.

Where a second reflector is provided, the ultrasound transducer arrangement may be configured to emit the outwardly travelling coherent ultrasound waves towards the second reflector.

In this case, the second reflector may be annular and extend around the ultrasound transducer arrangement. Such an arrangement allows the second reflector to receive outwardly travelling coherent ultrasound waves and direct them towards the first reflector. This allows the reactor to use a simple form of transducer arrangement.

For example, the ultrasound transducer arrangement may be configured to generate cylindrical, coherent ultrasound waves.

Alternatively where a second reflector is provided, the reflector arrangement may further comprise a third reflector arranged to receive the coherent ultrasound waves emitted by the ultrasound transducer arrangement, and to reflect them outwardly towards the second reflector.

In some embodiments, the third reflector is annular and the second reflector extends around the third reflector. This allows the third reflector to act as beam splitter that splits the ultrasound waves from the ultrasound transducer arrangement, which in turns allows the reactor to use a simple form of transducer arrangement.

These embodiments, including a first reflector and optionally also second reflector or both a second and third reflector, provide space-efficient folded arrangements for transmitting ultrasound waves from an ultrasound transducer arrangement to the reactor vessel, forming the counter-propagating waves discussed above. Such arrangements allow all the ultrasound energy generated by the ultrasound transducer arrangement to be captured and directed into the reactor vessel, no matter where the ultrasound transducer arrangement is positioned. This maximises the energy in the standing wave, minimising the electrical energy needed to achieve cavitation.

In some embodiments, the ultrasound transducer arrangement comprises a single ultrasound transducer. The high intensity provided by folding the waves in on themselves means that only one ultrasound source is needed, further reducing energy requirements of the reactor.

In some embodiments, the reactor vessel is a tube extending through the chamber for flowing the reactant through the reactor. Flowing reactants allows a continuous process to be used, making the reactor even more suitable to industrial use.

In some embodiments the ultrasound transducer arrangement is configured to generate coherent ultrasound waves that are pulsed. Conventional acoustic reactors have used continuous wave ultrasound in order to maintain the energy above the threshold for cavitation. Surprisingly it has been found that a high acoustic pressure is only needed for a short period. Thus pulsed waves can be used, lowering the average energy required. Furthermore, this allows temporal control of the reaction.

Some embodiments further comprise a temperature controller configured to control the temperature of the ultrasound medium and/or of the reactor vessel. For example, the ultrasound medium may be used as a heat bath for the reactor vessel.

Some embodiments further comprise a pressure controller configured to control the pressure in the reactor vessel. Advantageously, in the present arrangement the reactor vessel is separate from the ultrasound medium. This means that pressure control can be applied to only the smaller volume of the reactor vessel, rather than to the chamber as a whole.

Some embodiments further comprise a microphone (e.g. a passive cavitation detector) arranged to detect cavitation in the reactor vessel. The reactor may further comprise a feedback system configured to adjust one or more properties of the coherent ultrasound waves generated by the ultrasound generator arrangement based on a signal received from the microphone. Such embodiments provide a means of confirming that cavitation has been achieved, and for automatically controlling the ultrasound transducer arrangement to maintain desired cavitation properties.

According to a second aspect of the invention there is provided a method of generating cavitation in an acoustic reactor, the method comprising: transmitting coherent ultrasound waves into a chamber of the acoustic reactor, the chamber holding an ultrasound medium; and reflecting the coherent ultrasound waves in opposing directions into a reactor vessel positioned in the chamber so as to form a standing wave in the reactor vessel.

According to a third aspect of the invention there is provided a method of activating a chemical reaction, the method comprising: providing reactants in a reactor vessel, the reactor vessel positioned in a chamber of an acoustic cavitation reactor, the chamber holding an ultrasound medium; transmitting coherent ultrasound waves into the chamber; and reflecting the coherent ultrasound waves in opposing directions into the reactor vessel to form a standing wave in the reactor vessel.

The methods according to the second and third aspects of the present invention may each be performed using the reactor according to the first aspect of the present invention.

Embodiments of the invention will now be described, by way of example only, with reference to the accompanying drawings in which corresponding reference symbols indicate corresponding parts, and in which:

FIG. 1 schematically is a side cross-sectional view of an acoustic reactor;

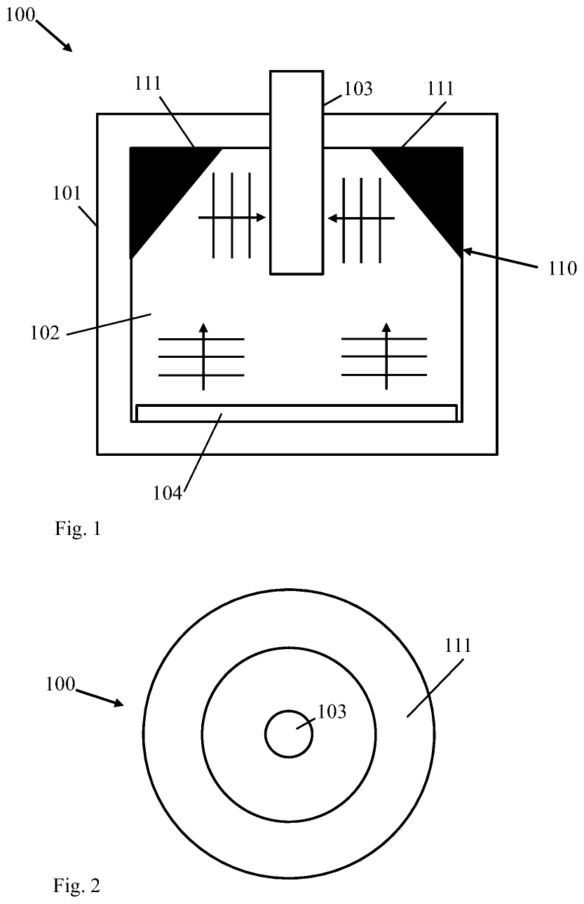

FIG. 2 is an internal plan view of the chamber and first reflector of the acoustic reactor of FIG. 1 in an annular configuration thereof;

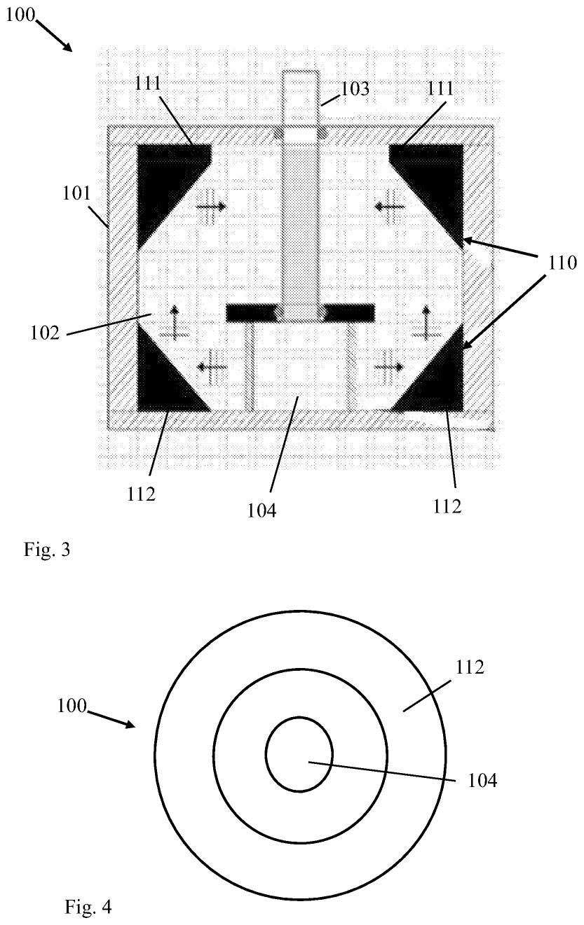

FIG. 3 is a side cross-sectional view of an acoustic reactor with an alternative reflector arrangement;

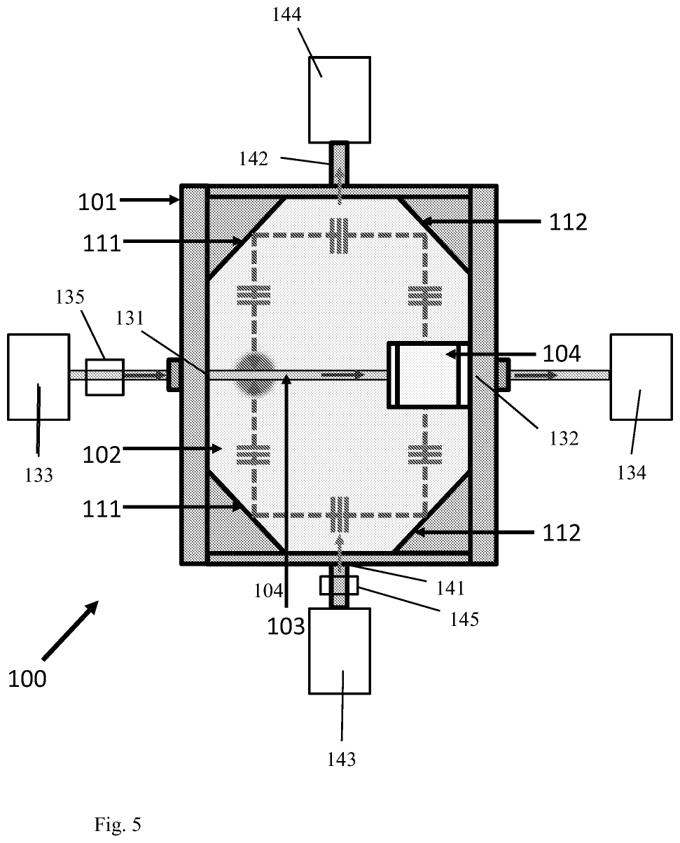

FIG. 4 is an internal plan view of the second reflector of the acoustic reactor of FIG. 3 in an annular configuration thereof;

FIG. 5 is a side cross-sectional view of an alternative example of the reactor of FIG. 3;

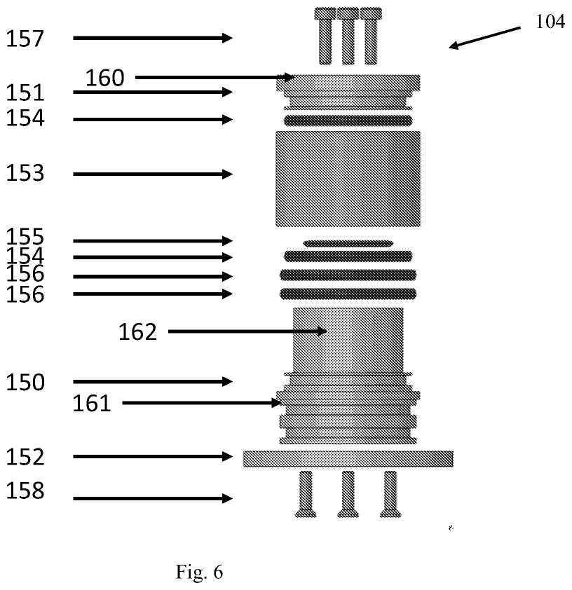

FIG. 6 is an exploded side view of the ultrasound transducer in the alternative example of FIG. 3;

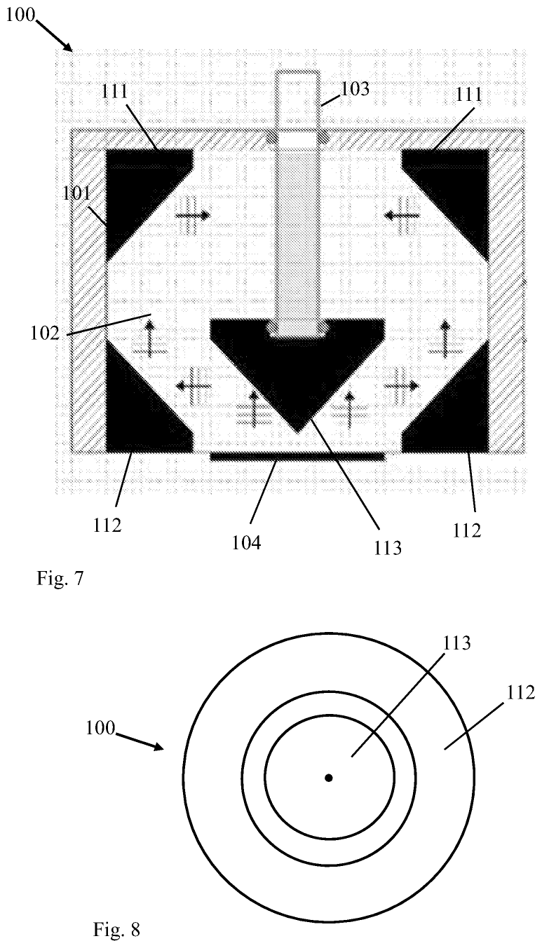

FIG. 7 is a side cross-sectional view of an acoustic reactor with a further alternative reflector arrangement;

FIG. 8 is an internal plan view of the second and third reflectors of the acoustic reactor of FIG. 7 in an annular configuration thereof;

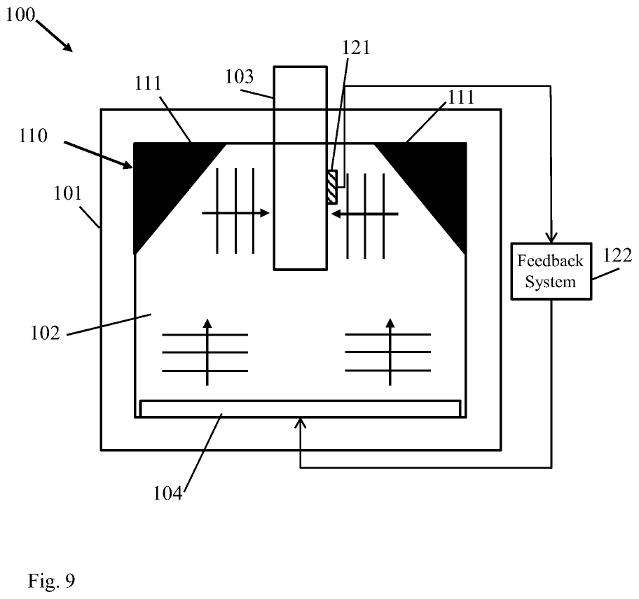

FIG. 9 is a side cross-sectional view of the acoustic reactor of FIG. 1 with a modification to include a feedback system;

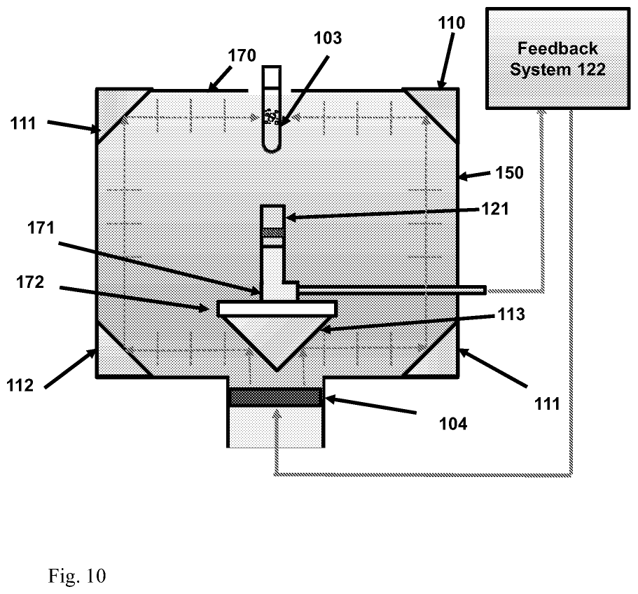

FIG. 10 is a side cross-sectional view of the acoustic reactor of FIG. 7 with a modification to include a feedback system;

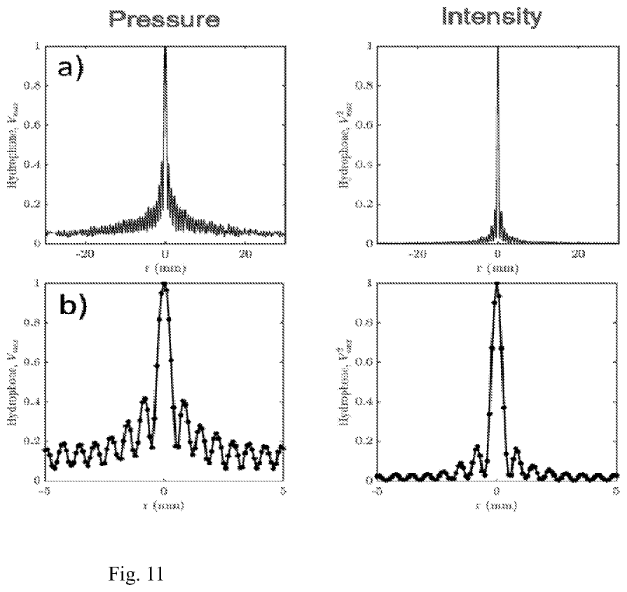

FIG. 11 illustrates measurements of acoustic pressure and intensity in a reactor vessel of an acoustic reactor using a cylindrical transducer;

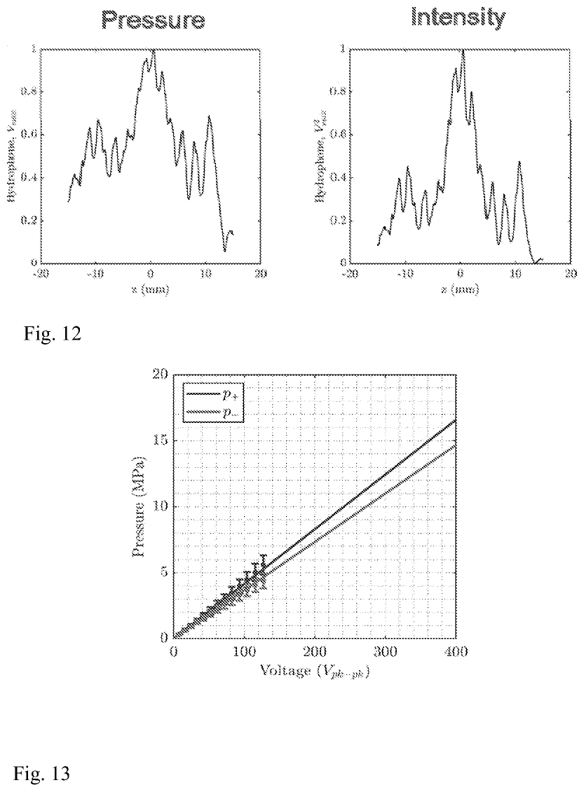

FIG. 12 illustrates measurements of acoustic pressure and intensity in a reactor vessel of an acoustic reactor using a plate transducer;

FIG. 13 illustrates acoustic measurements of peak acoustic pressure as a function of drive voltage of the ultrasound transducer arrangement;

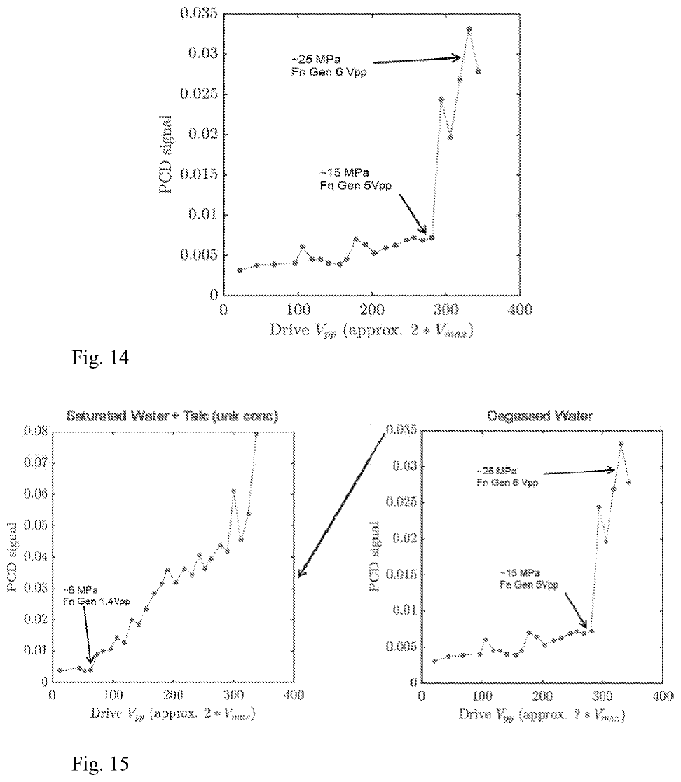

FIG. 14 illustrates PCD signals for different acoustic pressure amplitudes;

FIG. 15 illustrates cavitation thresholds for different materials;

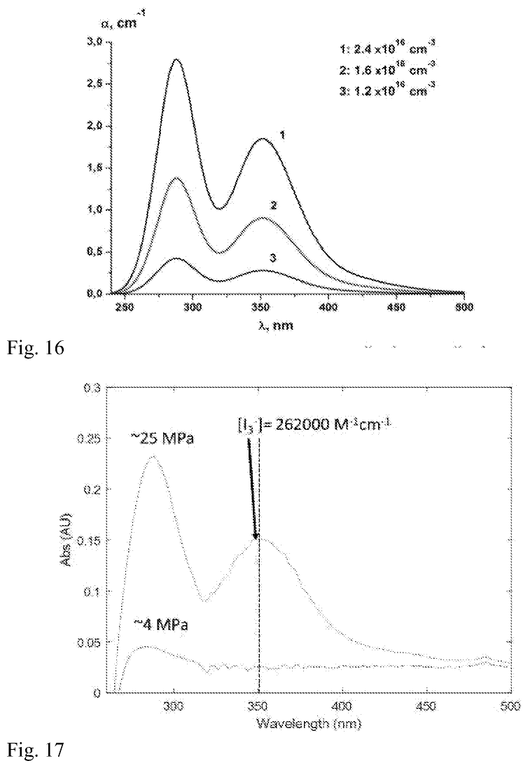

FIG. 16 shows absorption spectra of I₃⁻ in water at different concentrations;

FIG. 17 shows the UV-vis spectrum of 1M KI after ultrasound treatment in an acoustic reactor;

FIG. 18 compares the sonochemical efficiency (SE) of an ultrasound bath, a plate transducer, and an acoustic reactor according to the present disclosure;

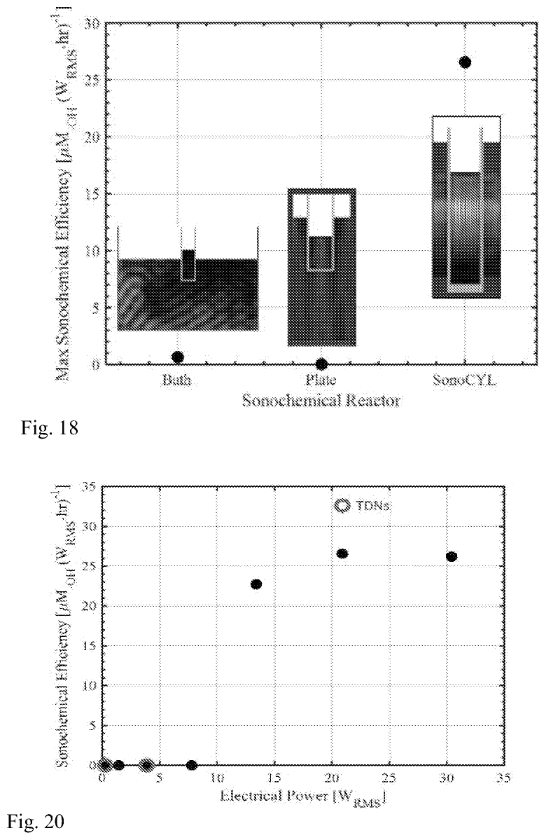

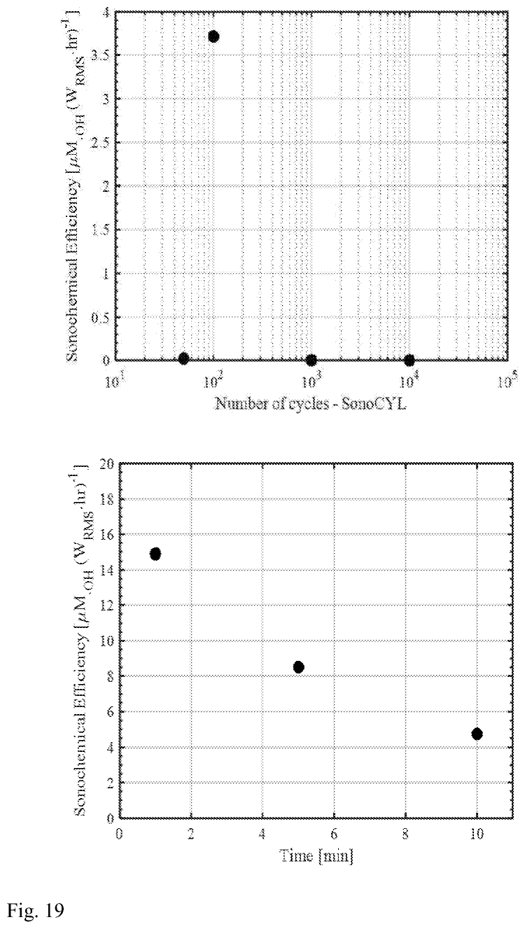

FIG. 19 illustrates the effect of the number of acoustic cycles and reaction time on SE;

FIG. 20 shows SE as a function of input electrical power;

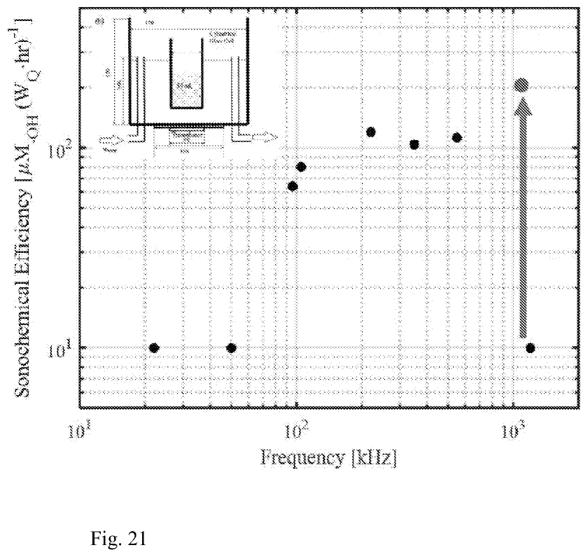

FIG. 21 is a comparison of SE of a plate transducer and an acoustic reactor;

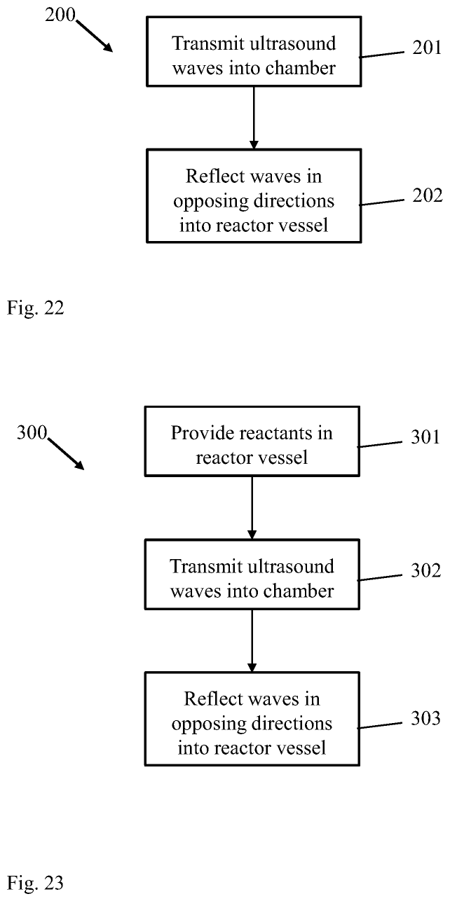

FIG. 22 illustrates a method of generating cavitation;

FIG. 23 illustrates a method of activating a sonochemical reaction;

FIGS. 24 to 30 are graphs of power against voltage for the cavitation noise generated in a set of experiments using an acoustic reactor of FIG. 10;

FIG. 31 is a graph of the normalized concentration conversion of tetracycline over time during experiment using the acoustic reactor of FIG. 10 at 865 kHz and 1.148 MHz; and

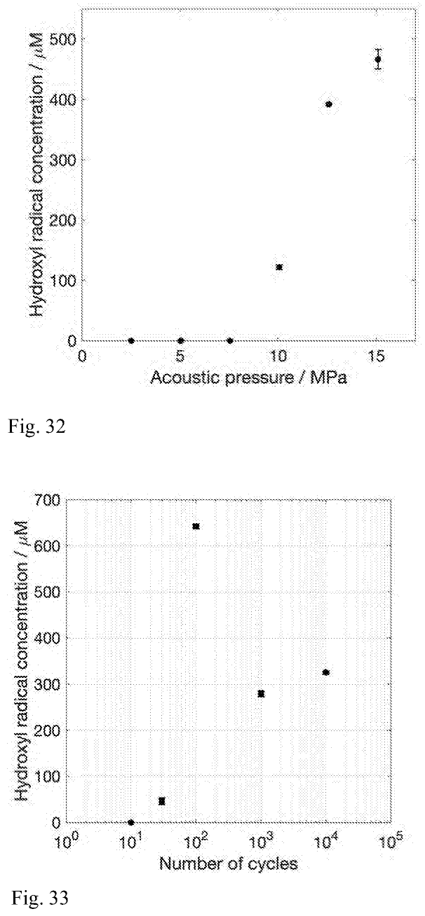

FIGS. 32 to 38 are graphs showing the results of experiment performed using an acoustic reactor of FIG. 3.

FIG. 1 illustrates an example of an acoustic reactor 100 according to the present disclosure. The acoustic reactor 100 may be a sonochemical reactor, intended for enabling sonochemical reactions, for example by inducing cavitation. The acoustic reactor 100 may be a cavitation reactor, i.e. a reactor intended for inducing cavitation. The acoustic reactor 100 may be used for purposes other than sonochemistry. For example, it may be used for gene delivery into cells.

The acoustic reactor 100 comprises a body 101 defining a chamber 102 for holding an ultrasound medium. The ultrasound medium provides a medium in which ultrasound waves can propagate. The ultrasound medium may be any liquid, preferably a liquid with low acoustic impedance. The ultrasound medium may particularly be selected to minimise acoustic reflections between the ultrasound transducer arrangement 104/ultrasound medium interface and/or provide low attenuation in the ultrasound medium to prevent energy loss to heat. In particular examples, the ultrasound medium is water, oil, or silicon oil. The body 101 may be formed of any material suitable for support the weight of the ultrasound medium to be held in the chamber 102. For example, the body 101 may be formed of an acrylic or stainless steel.

A reactor vessel 103 is positioned in the chamber. The reactor vessel 103 is for receiving a reactant, such as a reactant in a sonochemical reaction. In the illustrated example, the reactor vessel 103 is configured to hold the reactant statically in the reactor 100. To that end the reactor vessel 103 has a closed end within the chamber 102. Such an arrangement may be used for batch processing, for example. In alternative examples, the reactor vessel 103 is a tube extending through the chamber 102 for flowing the reactant through the reactor. Such an arrangement may be used for continuous processing, which is preferable for industrial applications. An example of a reactor 100 with a reactor vessel 103 for continuous flow is described below in relation to FIG. 5.

In general, the reactor vessel 103 has a diameter larger than the wavelength of the transmitted sound. Although there is no upper limit to the diameter in principle, larger diameters mean that there will be less total volume exposed to intense ultrasound waves, reducing efficiency. Preferably, the reactor vessel 103 is formed of a material having an acoustic impedance matched to the ultrasound medium surrounding it. The wall thickness of the reactor vessel 103 is preferably approximately a quarter wavelength of the transmitted ultrasound waves. For example, the wall thickness may be in a range from ⅛ to ⅜ the wavelength of the ultrasound waves. In general, the properties of the reactor vessel 103 may be selected to minimise reflections due to the interface between the ultrasound medium and the reactor vessel.

The reactor vessel 103 of the present disclosure is therefore separate from the chamber 102 of the reactor 100. This means that the ultrasound medium and any reactants/test fluids in the reactor vessel 103 are separated. Any bubbles generated in the reactor vessel 103, which change the impedance and hence ultrasound propagation characteristics of the reactants, are thus also separated from the ultrasound medium. This means that the changes in impedance are decoupled from the source of the ultrasound. In contrast, in conventional techniques the test liquid and the ultrasound medium are mixed together. In such conventional techniques, cavitation is not decoupled from the ultrasound source, and so cavitation changes the form of the generated ultrasound.

In some examples the reactor 100 is provided without the ultrasound medium in the chamber 102 and/or reactants in the reactor vessel 103. Thus the chamber may be fillable with an ultrasound medium, for example having an opening for receiving ultrasound medium. In alternative examples, ultrasound medium is provided in the chamber and/or reactant is provided in the reactor vessel 103.

The reactor 100 further comprises an ultrasound transducer arrangement 104. The ultrasound transducer arrangement 104 is configured to emit coherent ultrasound waves into the chamber 102. In example of FIG. 1, the ultrasound transducer arrangement 104 is represented as a planar (or disc) ultrasound source. Alternatively the ultrasound transducer arrangement 104 may be a cylindrical ultrasound source, or any other ultrasound source generating coherent ultrasound waves. In preferable examples, the ultrasound transducer arrangement 104 comprises a single ultrasound transducer. Using only one transducer reduces the electrical energy consumption of the reactor 100. The folded reflector arrangement of the present disclosure, discussed below, allows all the ultrasound generated by a single reactor to be collected and used, further increasing the efficiency of the reactor.

The ultrasound transducer arrangement 104 may be operated in any known manner. For the measurements demonstrated in FIGS. 11-21, discussed below, the ultrasound transducer arrangement 104 was driven by a voltage is generated by a function generator. The signal from the function generator was first passed to a dampener (in this example a −20 dB dampener), and then passed to an RF Amplifier. This was done to protect the RF amplifier. The now amplified signal (or drive voltage) was transmitted to the ultrasound transducer arrangement 104. An electrical impedance matching network may be used to minimize losses during electrical to acoustic energy conversion.

The ultrasound generated by the ultrasound transducer arrangement 104 may have a frequency in a range from 20 kHz to 5 MHz or preferably from 100 kHz to 1 MHZ, or more preferably from 300 to 500 kHz, or any combination of lower and upper values from these ranges.

The ultrasound transducer arrangement 104 may be configured to generate continuous wave ultrasound. However, preferably, the ultrasound transducer arrangement is configured to generate coherent ultrasound waves that are pulsed. It has been found that a high acoustic pressure is only needed for a short period. Thus pulsed waves can be used, lowering the average energy required. The minimum duty cycle of the pulsed ultrasound may be 5%, or 10%, or 20%. The maximum duty cycle of the pulsed ultrasound may be 50% or 60% or 70%. In preferable examples, the duty cycle is in the range from 10% to 50%.

The reactor 100 further comprises a reflector arrangement 110. The reflector arrangement 110 is arranged to reflect coherent ultrasound waves from the ultrasound transducer arrangement 104 in opposing directions into the reactor vessel 103 so as to form a standing wave in the reactor vessel 103. In other words, an ultrasound wave is folded in on itself to form counter-propagating coherent ultrasound waves. This configuration is such that these coherent counter-propagating waves overlap in the reactor vessel 103. The result is a standing wave formed in reactants/cavitation media held in the reactor vessel. The standing wave in the reactor vessel 103 then provides intense ultrasound pressure at the wave antinodes, sufficient to induce cavitation and hence induce sonochemical reactions. By controlling the properties of the ultrasound, the spatial position of the wave antinodes and nodes in the reactor vessel 103 can be controlled. The reflector arrangement 110 (and/or any individual reflectors thereof) preferably comprise a stainless steel surface. In general however the reflector arrangement 110 may be formed of any material suitable for reflecting ultrasound waves. In particular, the reflector arrangement 110 may comprise a material with a sufficiently different acoustic impedance to the ultrasound medium to provide reflection of ultrasound waves travelling in the ultrasound medium. For example, the reflector arrangement 110 may be selected to reflect at least 70%, or at least 80%, or at least 90%, or at least 95% of ultrasound waves incident upon it.

Preferably, the reactor 100 is configured such that a total path length of the ultrasound waves in the medium is at least twice the wavelength of the ultrasound waves in the medium. This ensures that the reactor vessel 103 is positioned in the far field of the ultrasound waves. The folded reflector arrangements 110 of the present disclosure provide this far field distance within a small spatial volume, reducing the overall size of the reactor 100. In particular examples, the longitudinal length of the chamber 102 is selected to provide sufficient distance between the ultrasound transducer arrangement 104 and the reactor vessel 103 for the waves to be in the far field.

In the example illustrated in FIG. 1, the reflector arrangement 110 comprises a first reflector 111 configured to receive coherent ultrasound waves from the ultrasound transducer arrangement, and to reflect them in the opposing directions into the reactor vessel.

Preferably the first reflector 110 is an annular reflector, extending continuously around the chamber 102 and around the reaction vessel 103, as shown in FIG. 2. The annular reflector may be circular, or any other shape, for example to match the cross-section of the chamber 102. When a circular annular reflector is used, the counter-propagating waves form an inwardly travelling cylindrical wave. This waveform focuses the ultrasound waves, and concentrates the power of the ultrasound waves providing a high intensity region in the reaction vessel 103 at the centre of the inwardly travelling cylindrical wave, capable of inducing cavitation. By focusing the energy of the wave in this way, the overall electrical energy input required to generate ultrasound waves is reduced, making the reactor 100 more efficient.

Preferably, the first reflector 111 is configured to receive coherent ultrasound waves from the ultrasound transducer arrangement 104 travelling along paths in parallel directions. In particular, the first reflector 111 may be configured to receive planar waves from the ultrasound transducer arrangement 104. The reflector 111 may be arranged to reflect waves by approximately 90°. Such arrangements simply the design of the reactor 100.

FIG. 3 illustrates an acoustic reactor 100 with an alternative reflector arrangement 110. In such examples, the reflector arrangement 110 includes a first reflector 111 arranged in the same manner as the example of FIG. 1, but further comprises a second reflector 112 configured to receive coherent ultrasound waves from the ultrasound transducer arrangement 104 travelling outwardly and to reflect them towards the first reflector 111. After reflection by the second reflector 112, the ultrasound waves travel as described above with reference to the example of FIG. 1.

In some such examples, as illustrated in FIG. 2, the ultrasound transducer arrangement 104 is configured to emit the outwardly travelling coherent ultrasound waves towards the second reflector 112. For example, the ultrasound transducer arrangement 104 may be configured to emit outwardly travelling cylindrical waves. In such examples, the reflector arrangement 110 is arranged to convert outwardly travelling counter-propagating waves into co-propagating waves, and then into inwardly travelling counter-propagating waves. In this way, (substantially) all the ultrasound waves generated can be collected and directed into the reactor vessel 103, no matter where the ultrasound transducer arrangement 104 is located. For example, as shown in FIG. 3, the ultrasound transducer arrangement 104 may be positioned directly below the reactor vessel 103 (relative to a longitudinal axis of the reactor vessel 103). This provides a space-efficient arrangement of components, reducing the overall size of the reactor 100, and allowing a single ultrasound transducer to be used to generate an intense acoustic pressures in the reactor vessel 103.

Preferably, the ultrasound transducer arrangement 104 is cylindrical and the second reflector 112 is an annular reflector, extending around the chamber 102 and around the ultrasound transducer 104, as shown in FIG. 4. The annular reflector may be circular, or any other shape, for example to match the cross-section of the chamber 102. Such an arrangement allows the second reflector 112 to collect outwardly travelling coherent ultrasound waves and direct them towards the first reflector 111. This is a convenient way to direct coherent ultrasound waves to the entirety of the first reflector 111, without the need to configure the ultrasound transducer arrangement 104 to extend across the entire area of the first reflector 111, which would be difficult to implement.

FIG. 5 shows an alternative example of the reactor 100 of FIG. 3. As with FIG. 3, the ultrasound transducer 104 of FIG. 5 is configured to emit the outwardly travelling coherent ultrasound waves towards the second reflector 112. The second reflector 112 directs waves towards the first reflector 111, which in turn reflects waves into the reactor vessel 103.

In this example, however, the reactor vessel 103 is a tube extending through the chamber 102. Thus, the reactor vessel 103 has an inlet 131 through which the reactants flow into the reactor chamber 102 and an outlet 132 through which the reactants flow out of the reactor chamber 102. The reactants may be supplied from a source chamber 133 connected to the inlet 131 and supplied to a collection container 134 connected to the outlet 132. Flow of liquid may be driven by a pump 135. This allows reactants to be flowed continuously through the reactor 100, whilst subjecting the reactants to the concentrated ultrasound waves. Thus such examples can be used for continuous reactions. In the particular example illustrated in FIG. 5, the reactor vessel 103 passes through the ultrasound transducer arrangement 104. As will be appreciated, an ultrasound transducer arrangement 104 configured to emit outwardly travelling waves, such as a cylindrical ultrasound transducer, may be particularly suited to such examples, as no part of the transducer surface is blocked by the reactor vessel 103. However, other examples with flow-through reactor vessels 103 may use other ultrasound transducer arrangements 104, such as that of FIG. 7.

In the example of FIG. 5, the ultrasound medium can flow through the reactor chamber 102. For this purpose, the reactor chamber 102 has an inlet 141 through which the ultrasound medium flows into the reactor chamber 102 and an outlet 142 through which the ultrasound medium flows out of the reactor chamber 102. The ultrasound medium may be supplied from a tank 143 connected to the inlet 141 and supplied to a reservoir 144 connected to the outlet 142. Flow of liquid may be driven by a pump 145.

The flow of ultrasound medium through the reactor chamber 102 allows for heat generated by the ultrasound transducer 104 or absorbed by the reaction vessel to be removed. The flow of the ultrasound medium maintains the temperature of the reactor chamber to a desired setpoint.

The flow system for the ultrasound medium may include other components for example a bubble trap (not shown) between the tank 143 and the inlet 141 for preventing the introduction of bubbles into the reservoir that would disperse the ultrasound and/or one or more vacuum pumps to lower the pressure of the ultrasound medium in the reactor chamber 102.

FIG. 6 shows the detailed construction of the ultrasound transducer 104 for the reactor shown in FIG. 5, which is arranged as follows. The transducer 104 comprises a body 150, a cap 151 and a bottom plate 152, which fit together and hold the following components together. The transducer 104 comprises a cylindrical transducer crystal 153 located between a top barrier 160 of the cap 151 and a middle barrier 161 of the body 150. Gaps are left between the transducer crystal 153 and the cap 151 and body 150 for the expansion and axial movement of the transducer crystal 153 during the vibration. The transducer crystal 153 extends around a top section 162 of the body 150, which has a narrower diameter than the transducer crystal 153 so that air can be trapped between the body 150 and the transducer crystal 153, forming an ‘air-backing’ which reflects the ultrasound propagating inwards radially. To prevent water entering into the trapped air and leaking at the connection between the transducer 104 and the reactor chamber 103, O-rings 154, 155 and 156 are applied at the contact surfaces. Bolts 157 and 158 are used for mounting the body 150, cap 151 and bottom plate 152 together. Clearance holes are left on the bottom plate 152 for extra bolts to fix the transducer to the reactor body 101.

FIG. 7 illustrates a further alternative reflector arrangement 110. In such examples, the reflector arrangement 110 includes a first reflector 111 and second reflector 112 arranged in the same manner as the example of FIGS. 3 and 5, but further comprises a third reflector 113 arranged to receive the coherent ultrasound waves emitted by the ultrasound transducer arrangement 104, and to reflect them outwardly towards the second reflector 112. Thus, the third reflector 113 acts as beam splitter that splits the ultrasound waves from the ultrasound transducer arrangement 104. This in turns allows the reactor 100 to use a simple form of ultrasound transducer arrangement 104.

Thereafter, the ultrasound waves travel as described above with reference to the example of FIG. 3.

As illustrated, such examples may comprise an ultrasound transducer arrangement 104 which generates planar waves. Compared to the example in FIG. 1, it can be seen that the arrangement of FIG. 7 ensures all the waves from the ultrasound transducer arrangement 104 are collected and directed into the standing wave, whereas in FIG. 1 some of the waves are directed towards the lower side of the reactor vessel 103, and so do not contribute to the standing wave.

Preferably, the second reflector 112 and the third reflector 113 are annular reflectors, extending continuously around the chamber 102, as shown in FIG. 8. The annular reflector may be circular, or any other shape, for example to match the cross-section of the chamber 102.

The example reactors 100 shown in FIGS. 1-8 have been shown with the ultrasound transducer arrangement 104 positioned co-axially with the reactor vessel and with each reflection being a reflection substantially through 90°, and with the reactor vessel 103 positioned approximately centrally between opposing surface of the first reflector 110. Similarly, the reactor 100 is arranged such that all waves have a substantially equal path length to the centre of the reactor vessel 103 (centre in a horizontal cross-section orthogonal to a longitudinal axis of the reactor vessel). Each of these factors forms a space efficient design, reducing the overall size of the reactor 100. However, it is to be appreciated that other designs may be used, for example with different positions of ultrasound transducer arrangement 104 and/or reactor vessel 103, and/or different reflection angles.

Furthermore, in preferable examples each of the first, second, and third reflectors 111, 112, 113 is an annular reflector, as described above in relation to the first reflector 111, and as shown in FIGS. 2, 4 and 8 for the respective reactors of FIGS. 1, 3 and 7. However, any or all of the reflectors 111-113 may take different forms. For example, any of the reflectors 111-113 may comprise multiple opposing reflectors. The dimensions of the reflectors may be selected to match the dimensions of the transmitting surface of the ultrasound transducer arrangement 103. For example, the height of the reflectors 111-113 in a longitudinal direction defined by the length of the chamber 102 may be approximately equal to the height of the transmitting surface of the ultrasound transducer arrangement 104 (for examples emitting waves outwardly) or to the diameter of the transmitting surface of the ultrasound transducer arrangement (for examples emitting planar waves).

Any of the reactors 100 described above may further comprise control mechanisms. In particular, some examples comprise a temperature controller configured to control the temperature of the ultrasound medium and/or of reactants in the reactor vessel 103. For example, the ultrasound medium may be heated to act as a heat bath for the reaction in the reactor vessel 103. Alternatively or additionally, the reactor 100 may comprise a pressure controller configured to control the pressure in the reactor vessel. In addition, as discussed above, the properties of the generated ultrasound may be controlled to control the spatial position of the peak ultrasound intensities in the reactor vessel 103. Thus the reactor 100 provides spatial control of nucleation of inertial cavitation, and hence of sonochemical reactions. Further, control of the duty cycle with which waves are generated provides temporal control of the reaction.

Additionally, some examples of reactor 100 comprise a microphone arranged to detect cavitation in the reactor vessel 103. Such a microphone 121 is illustrated in FIG. 9. The reactor of FIG. 9 is arranged similarly to that of FIG. 1, but it is to be appreciated that any examples of reactors 100 described above may be used. The microphone 121 may be a hydrophone or passive cavitation device (PCD) configured to passively listen for noise characteristic to cavitation. This provides confirmation that cavitation has occurred as expected.

Although illustrated as attached to an outer surface of the reactor vessel 103, the microphone 121 may be placed at any location within the acoustic wave path. The microphone 121 may be movable. For example, FIG. 10 shows a reactor similar to that of FIG. 7 with a microphone 121 in an alternative location and arranged as follows. In this case, instead of being located on the reactor vessel 103, the microphone 121 is mounted on the rear side of the third reflector 113 by a mounting arrangement comprising a holder 171 and a base 172.

The base 172, which may be acrylic, ensures the microphone 121 lies flat in order for its face to be perpendicular to a top plate 170 of the reactor vessel 103 to which the reactor chamber 102 is mounted.

The holder 171 is mounted on the base 172 and holds the microphone 121, ensuring that the microphone 121 is centered confocally with the focus of the ultrasound waves.

As well as detecting cavitation, the microphone 121 may be used as part of a feedback loop to control the generation of the ultrasound waves. To this end, examples may comprise a feedback system 122 configured to adjust one or more properties of the coherent ultrasound waves generated by the ultrasound generator arrangement based on a signal received from the microphone 121. The feedback system 122 may monitor the received signal to detect cavitation and, in response thereto, to change the parameters of the generated ultrasound waves in real-time. This may be performed while taking into the account the received noise.

For example, the feedback system 122 may comprise a data acquisition system to receive signal from the microphone 121, a means to process the signal to determine cavitation noise, and a signal generator to generate a signal to drive the ultrasound transducer arrangement 104 based on the signal from the microphone 121. Such an arrangement may for example be used to adjust the input into the ultrasound transducer arrangement 104 to ensure cavitation is occurring at each pulse of pulsed wave ultrasound. Cavitation may be impacted by changes in temperature, fluid degassing, and/or bubbles that manage to survive between pulses. The feedback arrangement may adjust for such factors throughout the reaction, providing control of chemical yield during the reaction.

To demonstrate the applicability of the reactors 100 described above, a microphone 121 was used to monitor the acoustic field within the reactor vessel 103. FIG. 11 shows spatial distribution of the acoustic pressure and intensity at the focus of the counter-propagating waves of the reactor 100 of FIG. 3 using a 1.092 MHz cylindrical transducer. Panel a) in FIG. 11 is the entire scan, and panel b) in FIG. 11 is a zoom in of the scan. FIG. 12 shows the spatial distribution of the acoustic pressure and intensity at the focus of the counter-propagating waves of the reactor 100 of FIG. 7 using 0.585 MHz disc transducer. From these hydrophone measurements, it is evident that the acoustic field is highly concentrated at the centre of the counter-propagating waves. This will be frequency dependent. A higher frequency will achieve a tighter focus. Here, at 1.092 MHZ the focus (as defined by the full width half maximum-FWHM) is less than 0.5 mm.

Using a hydrophone, it is also possible to calibrate the pressure amplitude of the focal region. FIG. 13 shows hydrophone measurements of peak positive (p+) and peak negative (p−) amplitudes from the reactor 100 of FIG. 3 at 1.092 MHZ at different drive voltages from the function generator. For the 1.092 MHZ cylindrical transducer it was possible to achieve up to an estimated 24 MPa of peak positive pressure. This is only an estimate based on a linear extrapolation from the calibration range. At these high intensities, it is possible that non-linearities of the acoustic wave may shift the maximum values for the peak positive and peak negative amplitudes.

As discussed above, the microphone 121 may be a passive cavitation device (PCD), arranged to passively listen for noise characteristic to cavitation. For simplicity, the output of such a PCD this is termed PCD signal. FIG. 14 shows PCD signals from the focus of a reactor 100 at different acoustic pressure amplitudes. From FIG. 14, it is evident that cavitation becomes a predominant source of noise at around 15 MPa and increases with increasing acoustic pressure amplitude.

The presence of cavitation can be nucleated more easily by adding cavitation nuclei. To this end, in some examples cavitation nuclei may be provided in the reactor vessel 103. Cavitation nuclei may include using gas-saturated water with talc added (or catalytic cavitation agents). FIG. 15 compares the cavitation threshold of talc using a reactor 100 compared to degassed water, demonstrating the impact that talc has on the nucleation of cavitation.

In any of the examples described above, the reactant(s) provided or to be received in the reaction vessel 103 may be any reactant suitable for a sonochemical or acoustic activated reaction. For example the reactant(s) may be or comprise one or more of: oxygen, nitrogen, water, ammonia, CO2, methane, sugars, starches, biomass, monomers. In addition the reactant(s), the reaction vessel 103 may be for receiving a cavitation agent (or a cavitation agent may be provided in the reaction vessel 103). For example the cavitation agent may be or comprise microbubbles, nanobubbles, nanodroplets, or nanoshells. The cavitation agent may be formed of a polymer, or any other material. In particular examples, the cavitation agent comprises titanium dioxide nanoshells. The acoustic reactor 100 may be for one or more of the following reactions: partial water splitting; oxidation reactions; reduction reactions; converting ammonia to hydrogen; converting ammonia to ammonium ions (potentially to chemicals such as hydrazine); nitrate/nitrite synthesis; sugar chemistry; selective oxidation; and polymer chemistry (radical polymerisations, etc.). In general the reactor 100 may be used for any sonochemical reaction, or any other acoustic activated reaction.

The majority of sonochemical reactions rely on the production of hydrogen radicals (H·) and hydroxyl radicals (·OH) from the sonolysis of water:

H2O→H·+·OH

It is important to note that other radical species may exist depending on the solvent conditions.

The reactors 100 described herein are able to achieve cavitation directly from water or with the addition of cavitation nuclei (as shown in FIGS. 14 and 15). To verify that this cavitation is able to achieve sonochemical reactions, the presence of radical generated by the cavitation from the following breakdown of water was evaluated. Here the presence of the hydroxyl radical is detected by using an aqueous solution of potassium iodide (KI), i.e., a Weissler reaction.

2·OH+2I⁻→2OH⁻+I2

I₂+I⁻→I₃⁻

As more hydroxyl radicals are produced, the iodide ion becomes a tri-iodide complex which is detectable by UV-vis spectroscopy with a known absorbance at 353 nm. From stoichiometry, we can determine the amount of hydroxyl radicals present. FIG. 16 shows the absorption spectra of I₃⁻ in water at different concentrations.

FIG. 17 shows the UV-vis spectrum of 1M KI after 10 minutes of ultrasound in a reactor 100 according to FIG. 3 (1.092 MHZ, 10% duty cycle). It is evident from the I₃⁻ peaks on the UV-vis spectrum in this figure that the reactor 100 can produce hydroxyl radicals directly from water.

FIG. 18 compares the sonochemical efficiency of the reactor 100 to a bath sonicator and a plate transducer (the reactor 100 is labelled “SonoCYL”). In each case an aqueous solution of 1M KI was exposed to ultrasound for 10 minutes. The amount of ultrasound varied between each sample due to the different operating conditions set by the device (e.g., driving power, frequency, pulse sequence, etc.). Thus, to best compare the results, the sonochemical efficiency of the reaction (SE) was determined using the equation below:

$$SE = \frac{m o 1 es per litre of desired product}{( U l t r a sound Power ) ( Totat reaction time )} [ = ] \frac{μ M}{W h r}$$

The inset illustrations of FIG. 18 show 2D simulations of the acoustic field within each reaction vessel.

The impact that the operational conditions of the reactor 100 of FIG. 3 (operating at 1.092 MHz) had on the SE of hydroxyl radical production was also studied. Two key factors were investigated: 1) reaction time; and 2) number of acoustic cycles per pulse. FIG. 19 shows the effect of number of acoustic cycles (left) and reaction time (right) on the SE. These results indicate that exposing the sample vessel 103 for too long will reduce the SE. This is likely to do with the impact of temperature changes, over-oxidation that might remove I₃⁻, or other affects not yet considered. Furthermore, there is an optimum number of acoustic cycles. Too few and there is not enough time to nucleate sufficient cavitation. Too many cycles and the cavitation bubbles may no longer inertially collapse due to rectified diffusion, coalescence, or other bubble-bubble interactions. The number of acoustic cycles may be in a range from 100 to 10000 cycles, or in a range from 500 to 5000 cycles.

The impact of input power into the reactor 100 was also explored. FIG. 20 shows that as power is increased, the SE also increases, but eventually plateaus. This test also included the presence of titanium dioxide nanoshells (TDNs) which are a catalytic cavitation agent which may be particularly suited for use in the reactors 100 described herein. Such TDNs are described in PCT application PCT/GB2021/053183, which is incorporated herein by reference in its entirety.

FIG. 20 compares the SE of a plate transducer (inset) and a reactor 100 (blue, larger, dot), at different operating frequencies. From this figure, the reactor 100 outperforms this conventional reactor setup at similar operating frequencies. It is noted that the definition of SE varies from research group to research group. Furthermore, SE is also dependent on reaction conditions (e.g., presence of inhibitors, stabilisers, and catalysts). The data presented in FIG. 21 are therefore a best attempt to fine other reactors operating under similar conditions to compare with the performance of the reactors 100 described here. In addition, ultrasound power was determined using the heat delivered by the acoustic wave, which is not an ideal means of determining acoustic power.

Therefore the reactors 100 described herein can generate cavitation, and be used to activate sonochemical reactions, with improved efficiency compared to conventional techniques.

FIG. 22 illustrates a method 200 of generating cavitation in an acoustic reactor 100. The method starts at step 201, at which coherent ultrasound waves are transmitted into a chamber 102 of the acoustic reactor 100, the chamber holding an ultrasound medium. At step 202, the coherent ultrasound waves are reflected in opposing directions into a reactor vessel 103 positioned in the chamber so as to form a standing wave in the reactor vessel.

FIG. 23 illustrates a method 300 of activating a chemical reaction, such as any of the reactions described above. The method starts at step 301, at which reactants are provided in a reactor vessel 103. The reactor vessel is positioned in a chamber 102 of an acoustic cavitation reactor 100, the chamber 102 holding an ultrasound medium. At step 302, coherent ultrasound waves are transmitted into the chamber 102. At step 303, the coherent ultrasound waves are reflected in opposing directions into the reactor vessel 103 to form a standing wave in the reactor vessel.

The methods 200 and 300 may employ any variation of the reactors 100 described above.

Some examples of results achieved using acoustic reactors 100 of the type shown in FIG. 10 with an annular configuration as described above are as follows, including reactions with cavitation nuclei and tetracycline, an antibiotic:

Carbon black, a cavitation nuclei, was placed in the reactor vessel 103 and exposed to ultrasound for increasing levels of pressure using the acoustic reactor 100. The driving frequency was 1.148 MHz with a pulse repetition pulse of 1 ms with bursts of 100 cycles per pulse. FIG. 247 shows the change of noise (harmonic, fundamental, broadband, and total power) received by the microphone 121 with increasing power input into the transducer 104, sonicating a gassy water sample with nuclei (carbon black).

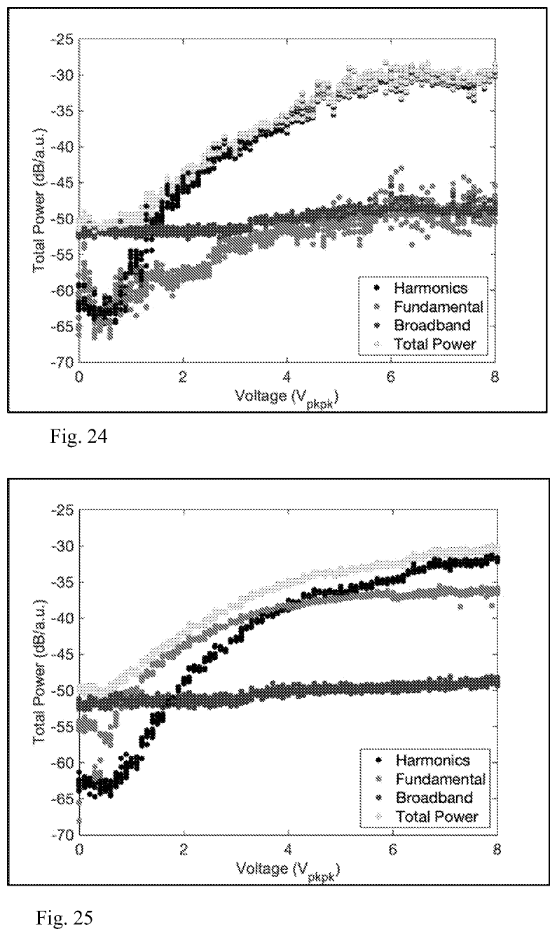

C3N4, a cavitation nuclei, was placed in the reactor vessel 103 and exposed to ultrasound for increasing levels of pressure using the acoustic reactor 100. The driving frequency was 1.148 MHz with a pulse repetition pulse of 1 ms with bursts of 100 cycles per pulse. FIG. 25 shows the change of noise (harmonic, fundamental, broadband, and total power) received by the microphone 121 with increasing power input into the transducer 104, sonicating a gassy water sample with nuclei (C3N4).

TiO2, a cavitation nuclei, was placed in the reactor vessel 103 and exposed to ultrasound for increasing levels of pressure using the acoustic reactor 100. The driving frequency was 1.148 MHz with a pulse repetition pulse of 1 ms with bursts of 100 cycles per pulse. FIG. 26 shows the change of noise (harmonic, fundamental, broadband, and total power) received by the microphone 121 with increasing power input into the transducer 104, sonicating a gassy water sample with nuclei (TiO2).

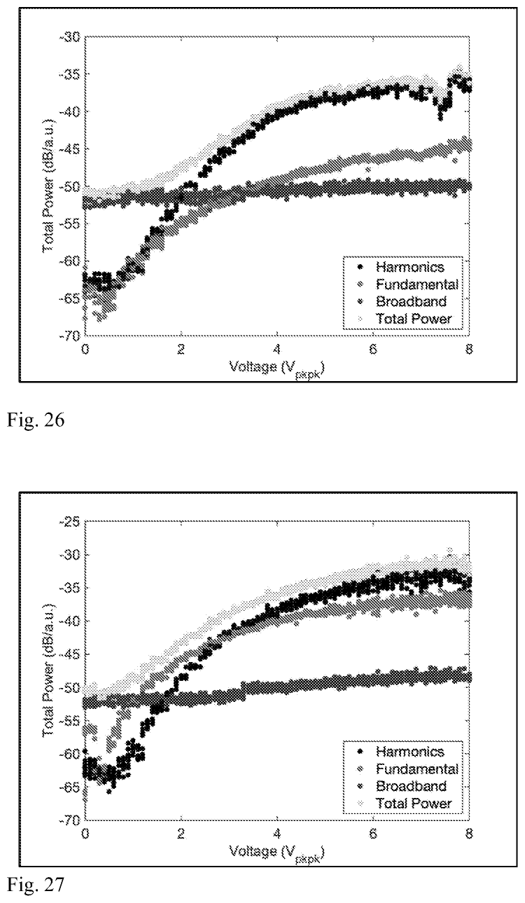

Sheet, a cavitation nuclei, was placed in the reactor vessel 103 and exposed to ultrasound for increasing levels of pressure using the acoustic reactor 100. The driving frequency was 1.148 MHz with a pulse repetition pulse of 1 ms with bursts of 100 cycles per pulse. FIG. 27 shows the change of noise (harmonic, fundamental, broadband, and total power) received by the microphone 121 with increasing power input into the transducer (104), sonicating a gassy water sample with nuclei (Shect). Figures of the cavitation noise can be seen on slide 20 of the OUI_PCD_Sonocyl_v4.pptx.

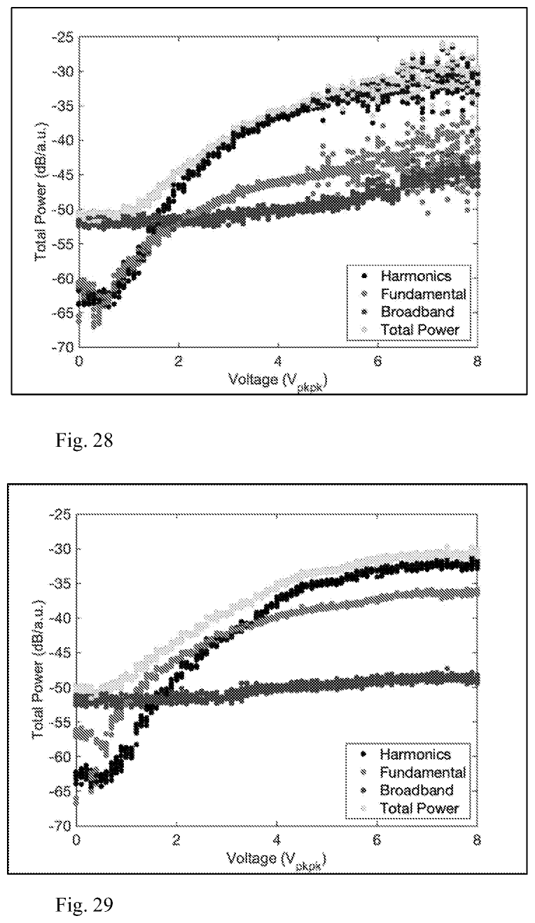

ZiF, a cavitation nuclei, was placed in the reactor vessel 103 and exposed to ultrasound for increasing levels of pressure using the acoustic reactor 100. The driving frequency was 1.148 MHz with a pulse repetition pulse of 1 ms with bursts of 100 cycles per pulse. FIG. 28 shows the change of noise (harmonic, fundamental, broadband, and total power) received by the microphone 121 with increasing power input into the transducer (104), sonicating a gassy water sample with nuclei (ZiF).

Gassy Water was placed in the reactor vessel 103 and exposed to ultrasound for increasing levels of pressure using the acoustic reactor 100. The driving frequency was 1.148 MHz with a pulse repetition pulse of 1 ms with bursts of 100 cycles per pulse. FIG. 29 shows the change of noise (harmonic, fundamental, broadband, and total power) received by the microphone 121 with increasing power input into the transducer (104), sonicating a gassed water.

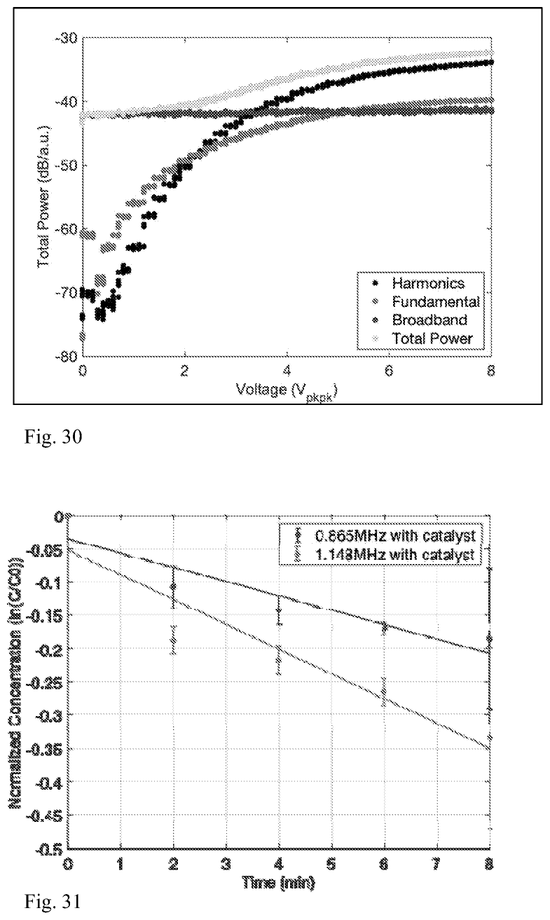

Degassed water was placed in the reactor vessel 103 and exposed to ultrasound for increasing levels of pressure using the acoustic reactor 100. The driving frequency was 1.148 MHz with a pulse repetition pulse of 1 ms with bursts of 100 cycles per pulse. FIG. 30 shows the change of noise (harmonic, fundamental, broadband, and total power) received by the microphone 121 with increasing power input into the transducer 104, sonicating a degassed water sample. Figures of the cavitation noise can be seen on slide 23 of the OUI_PCD_Sonocyl_v4.pptx.

Tetracycline, an antibiotic, was placed in the reactor vessel 103 and exposed to ultrasound for 2, 4, 6, 8, and 10 minutes using the acoustic reactor 100. The driving frequency was 1.148 MHz with a pulse repetition pulse of 1 ms with bursts of 100 cycles per pulse. FIG. 31 is a graph of normalized concentration over time, demonstrating the tetracycline conversion that was observed with an increase over time at 0.865 MHz and 1.148 MHz. Some examples of results achieved using acoustic reactors 100 of the type shown in FIG. 3 with an annular configuration and described above are as follows

In a first example, the reactants were a hydroxyl radical probe (Res-Cage) in phosphate-buffered saline buffer (PBS). The used ultrasound has an operating frequency of 1 MHz. FIG. 32 shows how the resultant hydroxyl radical varies with acoustic pressure, showing an acoustic pressure threshold of 7.5 MPa for the hydroxyl radical production.

In a second example, the reactants were a hydroxyl radical probe (Res-Cage) in phosphate-buffered saline buffer (PBS). The used ultrasound has an operating frequency of 1 MHz. FIG. 33 shows how the resultant hydroxyl radical varies with the number of cycles, demonstrating that the optimal number of cycles for hydroxyl radical production was 100.

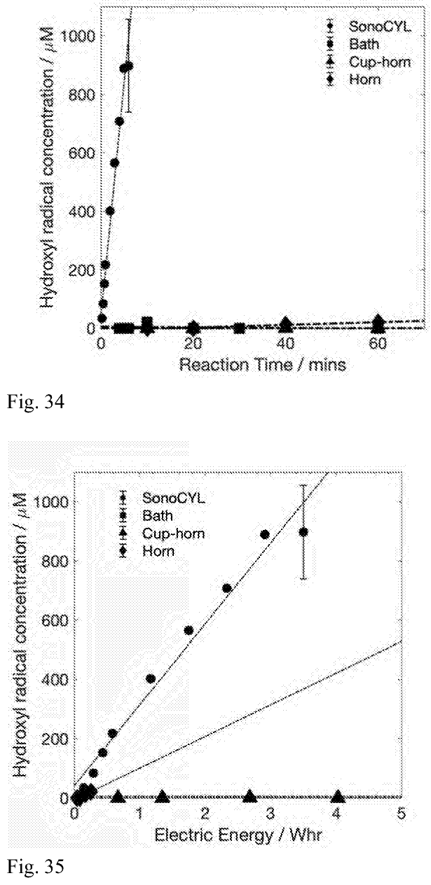

In a third example, the reaction was performed in the acoustic reactor and in three conventional reactors, that is an ultrasonic bath reactor, an ultrasonic cup-horn reactor, and an ultrasonic horn reactor. The reactants were a hydroxyl radical probe (Res-Cage) in phosphate-buffered saline buffer (PBS). The ultrasound frequencies were the resonance frequencies of the transducer in the four reactors. FIG. 34 shows how the resultant hydroxyl radical varies with time for all the reactors, demonstrating hydroxyl radical production rate of at least three orders of magnitude faster than the three conventional reactors.

In a fourth example, the reaction was performed in the acoustic reactor 100 and the same three conventional reactors as above. The reactants were a hydroxyl radical probe (Res-Cage) in phosphate-buffered saline buffer (PBS). The ultrasound frequencies were the resonance frequencies of the transducer in the four reactors. FIG. 35 shows how the resultant hydroxyl radical varies with electrical energy for all the reactors, demonstrating that the acoustic reactor 100 was twice as efficient to produce hydroxyl radicals compared to ultrasonic horn reactor, and at least three orders of magnitude higher compared to the cup-horn reactor and bath reactor.

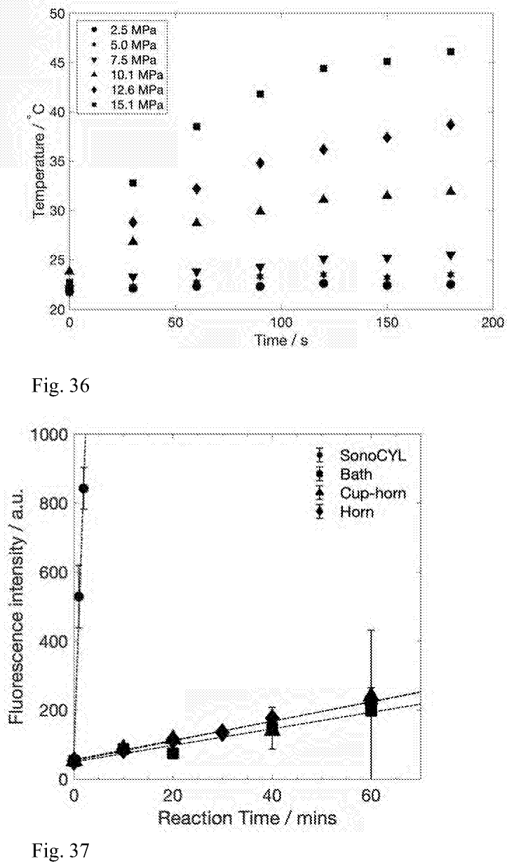

In a fifth example, the testing solution was water in the reaction vessel. FIG. 36 shows the variation of the temperature of the solution over the time that ultrasound was applied, at different acoustic pressures.

In a sixth example, the reaction was performed in the acoustic reactor 100 and the same three conventional reactors as above. The reactants were a hydroxyl radical probe (terephthalic acid assay) in phosphate-buffered saline buffer (PBS). The ultrasound frequencies were the resonance frequencies of the transducer in the four reactors. FIG. 37 shows the variation of fluorescence intensity with reaction time, demonstrating that the acoustic reactor 100 had at least two orders of magnitude faster hydroxyl radical production rate compared to the three conventional reactors.

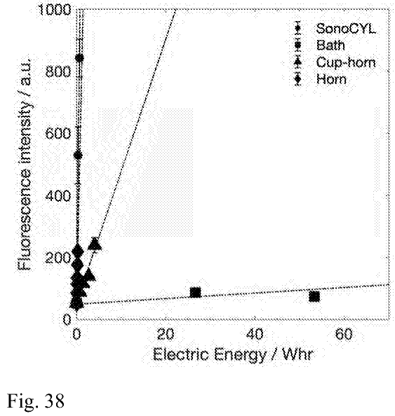

In a sixth example, the reaction was performed in the acoustic reactor 100 and the same three conventional reactors as above. The reactants were a hydroxyl radical probe (terephthalic acid assay) in phosphate-buffered saline buffer (PBS). The ultrasound frequencies were the resonance frequencies of the transducer in the four reactors. FIG. 38 shows the variation of fluorescence intensity with electrical energy, demonstrating that the acoustic reactor 100 was around twice as efficient to produce hydroxyl radicals compared to ultrasonic horn reactor and at least 30 times as efficient compared to the cup-horn reactor and bath reactor.

1. An acoustic reactor comprising:
a body defining a chamber for holding an ultrasound medium;
a reactor vessel for receiving a reactant, the reactor vessel positioned in the chamber;
an ultrasound transducer arrangement configured to emit coherent ultrasound waves into the chamber; and
a reflector arrangement arranged to reflect coherent ultrasound waves from the ultrasound transducer arrangement in opposing directions into the reactor vessel so the reflected acoustic waves form a standing wave in the reactor vessel.

2. The reactor of claim 1, wherein the reflector arrangement comprises a first reflector configured to receive coherent ultrasound waves from the ultrasound transducer arrangement, and to reflect them in the opposing directions into the reactor vessel.

3. The reactor of claim 2, wherein the first reflector is annular and extends around the reactor vessel.

4. The reactor of claim 2, wherein first reflector is configured to receive coherent ultrasound waves from the ultrasound transducer arrangement travelling along paths in parallel directions.

5. The reactor of claim 2, wherein the reflector arrangement further comprises a second reflector configured to receive coherent ultrasound waves from the ultrasound transducer arrangement travelling outwardly and to reflect them towards the first reflector.

6. The reactor of claim 5, wherein the second reflector is annular and extends around the chamber.

7. The reactor of claim 5, wherein the ultrasound transducer arrangement is configured to emit the outwardly travelling coherent ultrasound waves towards the second reflector.

8. The reactor of claim 7, wherein the second reflector is annular and extends around the ultrasound transducer arrangement.

9. The reactor of claim 8, wherein the ultrasound transducer arrangement is configured to generate cylindrical, coherent ultrasound waves.

10. The reactor of claim 6, wherein the reflector arrangement further comprises a third reflector arranged to receive the coherent ultrasound waves emitted by the ultrasound transducer arrangement, and to reflect them outwardly towards the second reflector.

11. The reactor of claim 10, wherein the third reflector is annular and the second reflector extends around the third reflector.

12. The reactor of claim 1, wherein the reactor is configured such that a total path length of the ultrasound waves in the medium is at least twice the wavelength of the ultrasound waves in the medium.

13. The reactor of claim 1, wherein the ultrasound transducer arrangement comprises a single ultrasound transducer.

14. The reactor of claim 1, wherein the reactor vessel is a tube extending through the chamber for flowing the reactant through the reactor.

15. The reactor of claim 1, wherein the reactor vessel is configured to hold the reactant statically in the reactor.

16. The reactor of claim 1, wherein the ultrasound medium is held in the chamber and/or the reactant is received in the vessel.

17. The reactor of claim 1, wherein the ultrasound waves have a frequency in a range from 20 kHz to 5 MHz, or from 100 kHz to 1 MHz, or from 300 kHz to 500 kHz.

18. The reactor of claim 1, wherein the ultrasound transducer arrangement is configured to generate coherent ultrasound waves that are pulsed.

19. The reactor of claim 18, wherein the pulsed coherent ultrasound have a duty cycle in a range from 10% to 70%, or from 10% to 50%.

20. The reactor of claim 1, further comprising a temperature controller configured to control the temperature of the ultrasound medium.

21. The reactor of claim 1, further comprising a pressure controller configured to control the pressure in the reactor vessel.

22. The reactor of claim 1, further comprising a microphone arranged to detect cavitation in the reactor vessel.

23. The reactor of claim 22, further comprising a feedback system configured to adjust one or more properties of the coherent ultrasound waves generated by the ultrasound generator arrangement based on a signal received from the microphone.

24. The reactor of claim 1, wherein the reactant is one or more of oxygen, nitrogen, water, ammonia, carbon dioxide, methane, a sugar, a starch, biomass, or monomers.

25. A method of generating cavitation in an acoustic reactor, the method comprising:
transmitting coherent ultrasound waves into a chamber of the acoustic reactor, the chamber holding an ultrasound medium; and
reflecting the coherent ultrasound waves in opposing directions into a reactor vessel positioned in the chamber so that the reflected ultrasound waves form a standing wave in the reactor vessel.

26. A method of activating a chemical reaction, the method comprising:
providing reactants in a reactor vessel, the reactor vessel positioned in a chamber of an acoustic cavitation reactor, the chamber holding an ultrasound medium;
transmitting coherent ultrasound waves into the chamber, and
reflecting the coherent ultrasound waves in opposing directions into the reactor vessel so that the reflected ultrasound waves form a standing wave in the reactor vessel.
